(19) United States
(12) Patent Application Publication
(10) Pub. No.: US 2026/0019673 A1
(43) Pub. Date: Jan. 15, 2026

(54) DYNAMIC CONTENT SCHEDULER

(71) Applicant: Atmosphere.tv, Austin, TX (US)

(72) Inventors: Zachary D. Hobbs, Austin, TX (US); Brent A. Hays, Austin, TX (US); Jeffrey C. DiTullio, Austin, TX (US)

(21) Appl. No.: 18/767,440

(22) Filed: Jul. 9, 2024

(51) Int. Cl. H04N 21/458

(52) U.S. Cl. CPC H04N 21/458

(57) ABSTRACT

Systems and methods are disclosed for implementing a dynamic content scheduler to automatically control the output of a streaming device. In certain embodiments, a method may comprise implementing a dynamic content scheduler for a streaming device, including determining a content source device connected to the streaming device, determining all content available to the streaming device based on the content source device, generating a content schedule of video to play at the streaming device based on the all content, and controlling the streaming device to play the video based on the content schedule, including directing the streaming device to send control signals to the content source device.

### SUMMARY

In certain embodiments, a method may comprise implementing a dynamic content scheduler for a streaming device, including determining a content source device connected to the streaming device, determining all content available to the streaming device based on the content source device, generating a content schedule of video to play at the streaming device based on the all content, and controlling the streaming device to play the video based on the content schedule, including directing the streaming device to send control signals to the content source device.

In certain embodiments, a system may comprise a streaming service configured to implement a dynamic content scheduler for a streaming device, the streaming service physically remote from the streaming device. The system may receive information from the streaming device identifying a content source device connected to the streaming device, determine all content available to the streaming device based on the content source device, generate a content schedule of video to play at the streaming device based on the all content, and control the streaming device to play the video based on the content schedule, including directing the streaming device to send control signals to the content source device.

In certain embodiments, a memory device may store instructions that, when executed, cause a processor to perform a method comprising implementing, via a streaming service physically remote from a streaming device, a dynamic content scheduler for the streaming device, including determining a content source device connected to the streaming device, determining all content available to the streaming device based on the content source device, generating a content schedule of video to play at the streaming device based on the all content, and controlling the streaming device to play the video based on the content schedule, including directing the streaming device to send control signals to the content source device.

### BRIEF DESCRIPTION OF THE DRAWINGS

FIG. 1 is a diagram of a system configured to implement a dynamic content scheduler, in accordance with certain embodiments of the present disclosure;

FIG. 2 is a diagram of a system configured to implement a dynamic content scheduler, in accordance with certain embodiments of the present disclosure;

FIG. 3 depicts a flowchart of an example method for implementing a dynamic content scheduler, in accordance with certain embodiments of the present disclosure; and

FIG. 4 is a diagram of a system configured to implement a dynamic content scheduler, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a physical device, such as a computer readable storage medium or memory device, including instructions that, when executed, cause a processor to perform the methods.

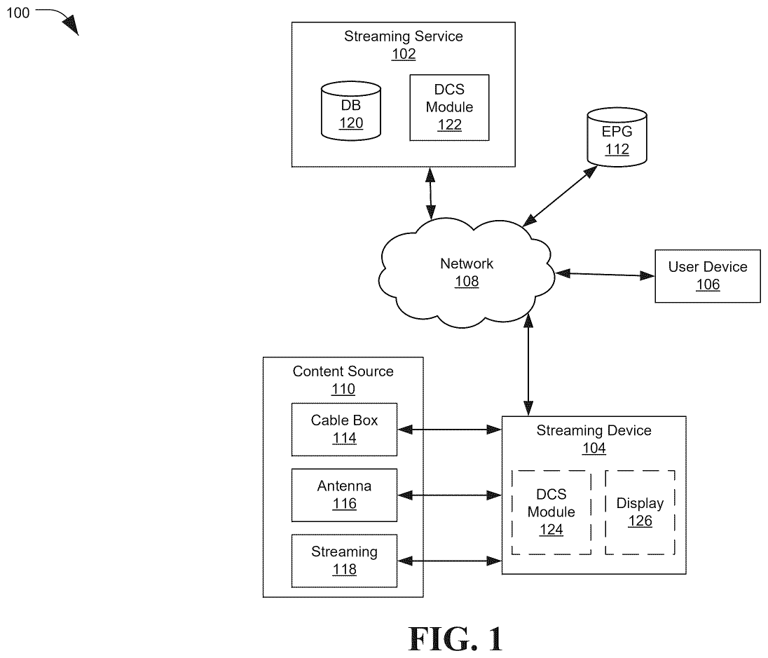

FIG. 1 depicts a diagram of a system 100 configured to implement a dynamic content scheduler, in accordance with certain embodiments of the present disclosure. The system 100 may include a streaming service 102, a streaming device 104, a user device 106, one or more content sources 110, one or more electronic program guides (EPGs) 112, and a network 108 over which the components of system 100 may communicate and exchange data. Each or any of streaming service 102, streaming device 104, user device 106, content source 110, EPG 112, and network 108 may be implemented via computers, servers, hardware and software modules, or other system components.

Streaming services 102 may offer a variety of content to consumers, such as various channels and genres or types of video, sports, television programming, movies, and more. However, content rights and availability have become fragmented across various services, platforms, and delivery mediums. Desirable content may be spread across multiple different video on demand (VOD) streaming services, cable providers, antenna broadcasts, satellite, over the top (OTT) internet television service, and other sources. For example, sports broadcast rights may be dispersed so that viewers cannot watch all games or matches with a single package, and may need to utilize several media sources. A user may be required to regularly switch viewing platforms or sources to watch the content they want to see, and keeping track of what content is available where may become burdensome.

The problem may be exacerbated when a user must utilize multiple different input sources or devices to access desired content on their television or other viewing device, which may require active user intervention to toggle between television input sources and then navigate through menus of the input device to reach desired content. Of particular note may be televisions or screens showing at public venues, such as restaurants, bars, lounges, or similar locations. Employees may need to monitor what is playing on the screens, and then locate and utilize remote controls or other input apparatus to switch to a different input, and potentially require other remotes to control the attached input devices. Businesses may prefer to just set televisions up with a single input device and channel, rather than monitoring and changing input or channel settings. To address these issues, system 100 provides an implementation for a dynamic content scheduler.

Streaming service 102 may support, control, or maintain streaming device 104. For example, streaming service 102 may publish, update, or maintain software or firmware modules to enable the operation of streaming device 104, and enable continued interoperability between streaming device 104 and other devices to which streaming device 104 may connect and interact. In some examples, streaming service 102 may generate, publish, or broadcast streaming content to streaming device 104. Some or all of the content, such as video segments or advertisements, may be obtained or transmitted from other content providers (not shown), for example based on distribution licensing agreements. In some embodiments, the streaming service 102 may acquire (e.g., download) content from the other content providers and generate streaming content to send to streaming device 104 over network 108. The streaming service 102 may provide a plurality of content feed options, such as multiple channels or content categories. Streaming service 102 may be configured with the capability to adjust or change behavior at the streaming device 104 (e.g., through commands sent via network 108) to change the channel or content feed displaying at the streaming device 104, adjust the volume or display settings, or otherwise modify the content being presented at streaming device 104.

Further, streaming service 102 may include one or more data storage devices, data storage mediums, data storage servers, and related data structures, collectively referred to as database (DB) 120. DB 120 may store information about streaming device 104 or associated client systems or accounts, streaming content data, or other information. For example, DB 120 may store a unique device identifier of streaming device 104, and demographic or attribute information associated with the streaming device, such as a type of account, a geographic location of the streaming device, and a type of venue in which the device is situated (e.g., a private home, or a public restaurant, sports bar, activity center, or other location). In some embodiments, the DB 120 may store a history of content viewed at streaming device 104, user viewing or content preferences, and user- or automatically-generated content schedules, according to embodiments discussed herein.

Streaming device 104, such as computers, smartphones, set-top boxes, or televisions, may receive video content feeds, such as video on demand (VOD), live broadcasts, or other streaming content.

Streaming device 104 may include or be connected to a display 126, which may be a television, monitor, digital billboard, computer, smartphone, or other device having a digital display element.

Streaming device 104 may receive streamed content, such as from streaming service 102 or other content sources via network 108, and perform any data conversion necessary to display the streaming content on display device 126. In some examples, a business may connect streaming device 104 to a television or video display device 126 at the business location (e.g., at a bar or restaurant) for the entertainment of customers. Streaming content may include both video segments and advertisements, as well as supplemental overlay data, such as news tickers, sports scores, stock market updates, a listing of current or upcoming video segments, or other data. Further, the streaming device 104 may also generate or display a dashboard, home screen, or other menu or navigation screen on the display 126 via which a user may select content sources or channels to play.

Streaming device 104 may be configured to be controlled via one or more local control options, such as a physical remote control, control elements on the streaming device itself, or other local inputs. As used herein, local controls or local inputs may include control devices physically proximate to the streaming device 104, which may send inputs from the control device to the streaming device 104 via wired electrical connections, infrared signals, Bluetooth, local Wi-Fi, radio frequency, or other limited-range transmission options. Streaming device 104 may also be controlled remotely, for example based on control commands from streaming service 102, user device 106 (e.g., via a web-based interface over Wi-Fi), or other means.

Instead of or in addition to receiving media content over network 108, streaming device 104 may also be connected to or receive media content from one or more other content sources 110. Content sources 110 may include devices that may plug into streaming device 104 (e.g., via HDMI cables, coaxial cables, or other physical or wired connections), or connect to streaming device 104 via local Wi-Fi, Bluetooth, or other limited-range wireless transmission options. Content source 110 may include a cable box 114, satellite television box, or other broadcast feed device. Another example content source may include an antenna (e.g., digital or analog) for receiving local broadcast transmissions. Content sources 110 may also include a streaming box 118, such as a set-top box or dongle that provides internet streaming content. Content sources 110 may provide content for display on display screen 126, for example via plugging into streaming device 104, which is itself connected to display 126.

Electronic program guides (EPGs) for one or more of the content sources 110 may be stored to a database or other data source 112. EPGs 112 may include data on programming or content schedules available via the various content sources 110, such as what shows, movies, sporting events, or other media is available from the content sources 110, and on what channel and what time. The EPGs 112 may provide current and upcoming schedules, and may be updated continually or periodically. In addition to program guides, EPG 112 may include other data sources indicating when programming may begin or end. For example, an online service may provide live sports scores, which may be used to determine whether broadcast sporting events are still ongoing or have ended.

User device 106 may include a computing device such as a smartphone, tablet, laptop, or other personal computing system. A user may access or change settings for streaming device 104 via user device 106, for example by accessing streaming device 104 or streaming service 102 via network 108. In an example, user device 106 may be used to select programming or content to display via streaming device 104. The content may be selected to play immediately, or may be added to a schedule to control the output of streaming device 104 over time.

In order to implement a dynamic content scheduling system as described herein, streaming service 102 may be equipped with a dynamic content scheduler (DCS) module 122, streaming device 104 may be equipped with DCS module 124, or both. For ease of explanation, operation of a dynamic content scheduler module will be provided in reference to DCS module 122 at streaming service 102 unless otherwise specified, although the described operations may also apply to DCS module 124.

DCS module 122 may interface with an exchange messaging with streaming device 104. When a content source 110 is connected to streaming device 104, the streaming device 104 may determine what the content source device is, for example via extended display identification data (EDID) shared between the content source and the streaming device 104 over an HDMI input port. The streaming device 104 may share details of the attached content source 110 devices to streaming service 102 (e.g., to DCS module 122), so that streaming service 102 may monitor what content sources are available to which streaming device 104. The streaming service 102 may use the identified content sources 110 to look up or access EPG data 112 for the channels or content available from each content source 110. Streaming service 102 or streaming device 104 may update a user interface (UI) dashboard or home screen to add each content source 110 or its associated content as a tile on the dashboard. By adding the content sources 110 to the streaming device 104 dashboard, a user may be able to access all available content for streaming device 104 via a single unified interface.

The DCS module 122 may be configured to generate a schedule to control the play of content at streaming device 104, which schedule can include content from streaming service 102 or any other content source 110 connected to streaming device 104. The schedule may be generated by a user, such as via a user device 106 or streaming device 104 accessing a web front-end or app user interface (UI) for the streaming service 102. In another example, the schedule may be generated by an operator or administrator for streaming service 102, such as based on preferences indicated by a customer of streaming device 104 (e.g., family-friendly programming, or “Thursday nights are trivia nights”), information about a venue where streaming device 104 is located (e.g., sports programming for a sports bar), or other information. In some embodiments, the streaming service 102 may monitor viewing habits or trends at streaming device 104, and store viewing history data to database 120. Based on the viewing history, a machine learning model (e.g., an artificial intelligence algorithm or AI) may automatically generate a schedule to apply at streaming device 104. For example, if streaming device 104 is always set to play Sunday night football and trivia on Thursdays, an automatic schedule generating algorithm of the streaming service 102 may create a schedule that automatically sets the streaming device 104 to play the scheduled content without a user being required to manually change the input and channel.

The streaming service 102 may be configured to access and utilize EPG 112 information for generation of the schedule. For example, EPGs 112 may be provided for various channels of streaming service 102 or content sources 110, and a user or administrator may use the EPGs 112 to select content to add to the schedule. Similarly, a schedule generation algorithm of streaming service 102 may search the EPGs 112 for content to add to the schedule based on viewing history, user-specified interests, demographics information, or other data. Further, streaming service 102 may monitor for changes to the EPGs 112, such as if a scheduled show or movie is removed, or if a live score reporting service indicates that a sporting event is running long. Based on the detected changes, the streaming service 102 may update the schedule dynamically, such as by keeping a channel set to a sporting event that is running long rather than changing the channel at a set time.

Based on the generated content schedule, streaming service 102 may send control signals (e.g., via network 108) to streaming device 104 to change the channel, input, or both, in order to play the scheduled content from the corresponding content source 110. Based on the received signals, the streaming device 104 may generate control commands to control the output of the corresponding content source 110 device. For example, streaming device 104 may generate consumer electronic control (CEC) signals or commands, and transmit them over an HDMI connection to, e.g., cable box 114 or streaming box 118.

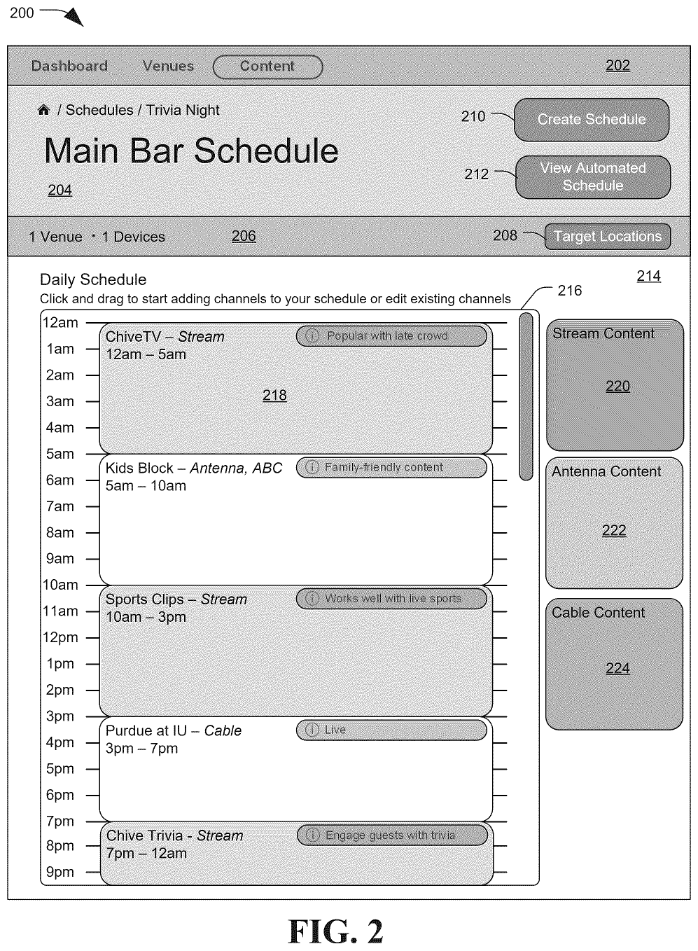

In this manner, a display 126 at a home or venue may be configured to switch between any desired content at any time, from any number of content sources 110, without any in-the-moment human intervention. This may alleviate the issues of having multiple content sources 110 attached to a display, of having to manually switch channels, and of having to monitor the display 126 to keep desired content playing. An example user interface for a dynamic content scheduler is described in regard to FIG. 2.

FIG. 2 depicts a diagram of an example system 200 configured to implement a dynamic content scheduler, in accordance with certain embodiments of the present disclosure. In particular, FIG. 2 presents an example embodiment of a user interface (UI) for viewing or setting a content schedule for a streaming device. In some embodiments, the system 200 of FIG. 2 may be implemented by elements of system 100 of FIG. 1, such as streaming service 102, streaming device 104, or user device 106. For example, the schedule may be maintained by streaming service 102 on the backend, while the user interface for viewing and managing the schedule may be displayed via user device 106 or streaming device 104.

Example system 200 may include a navigation bar 202, which may include links or buttons to access a dashboard, venue settings, and content settings. A dashboard may represent a home screen or system overview, and in some embodiments may be where a user may select between all available content sources or channels for the streaming device. A venue settings menu may allow a user to set up or configure venues associated with their streaming device or account. For example, a customer account may be for a chain of restaurants, and each restaurant may have a corresponding venue. Each venue may cater to a different clientele, or may follow a different weekly schedule for what screens should display at various times. Each venue may potentially have one or more streaming devices and associated screens. Accordingly, the venue page or menu may be used to set up or manage associated devices, preferences, demographics, or other details. A content menu may be used to manage content sources or set up, manage, or view content schedules. In the example of system 200, the UI may be set to the content menu.

System 200 may include a submenu navigation bar 204, which may be used to navigate within available features or submenus of the content menu of main navigation bar 202. The submenu navigation bar 204 shows that a user is navigated to a path “home/schedules/trivia night”, for a “Main Bar Schedule” target venue or device. The submenu navigation bar may show that the user is viewing a UI for viewing, creating, or editing a schedule for one or more target venues or devices (e.g., for a main bar), for a selected day or timeframe (e.g., Trivia night). In some embodiments, different time periods may be selected, such as to allow a different schedule for each day of the week, or for multiple days to follow a same schedule. An associated target bar 206 may indicate that the schedule to be viewed, created, or modified is for one selected venue and one selected device. The target venues or devices may be modified via a “target locations” 208 button or link on the target bar 206.

The submenu navigation bar 204 may include buttons or links to “create schedule” 210, and to “view automated schedule” 212. The create schedule button 210 may allow a user to create a new or fresh schedule for the target venue or devices on the specified day or timeframe. The view automated schedule button 212 may show the user a proposed auto-generated schedule for the target venue or devices during the specified timeframe. For example, the automated schedule may be generated based on user preferences, prior viewing history, demographics of the target venue or devices, or other information. A user may choose to adopt the automated schedule, use the automated schedule as a template to modify, or create or modify a user-generated schedule.

The system 200 may also depict a schedule view window 214. The schedule view window 214 may depict the currently selected user-generated or automatically generated schedule for the target venue or device and timeframe. The schedule view window 214 may depict a content schedule 216, showing time periods (e.g., an hour-by-hour breakdown) and what content is scheduled to play during those time periods.

Each content block 218 within the schedule 216 may list details such as what the content block or channel is called, a content source for the content (e.g., stream, cable, or antenna and a selected broadcast channel), a time period for the content block, and a informational description or blurb of the content.

The schedule view window 214 may also include a set of tiles or links for each available content source, such as stream content 220, antenna content 222, or cable content 224. The content sources may correspond to content available from any content source device 110 connected to the streaming device for the target venue or device. In some examples clicking on or selecting one of the content sources may direct a user to more details, such as an EPG for channels available through the content source.

A user may click on a content block 218 of content schedule 216 to modify the block, or may drag elements from content schedule 216 or the available content sources to add, remove, or edit entries on the content schedule 216. For example, dragging the “cable content” box 224 onto a time period of the content schedule 216 may pull up an option of channels available through cable and what programming will be playing at the selected time period on the various channels. A user may then select which channel to play from the cable content 224 options. The selected content may then appear on the content schedule 216, and the schedule 216 may further reflect specific programming on the selected channel at different time periods.

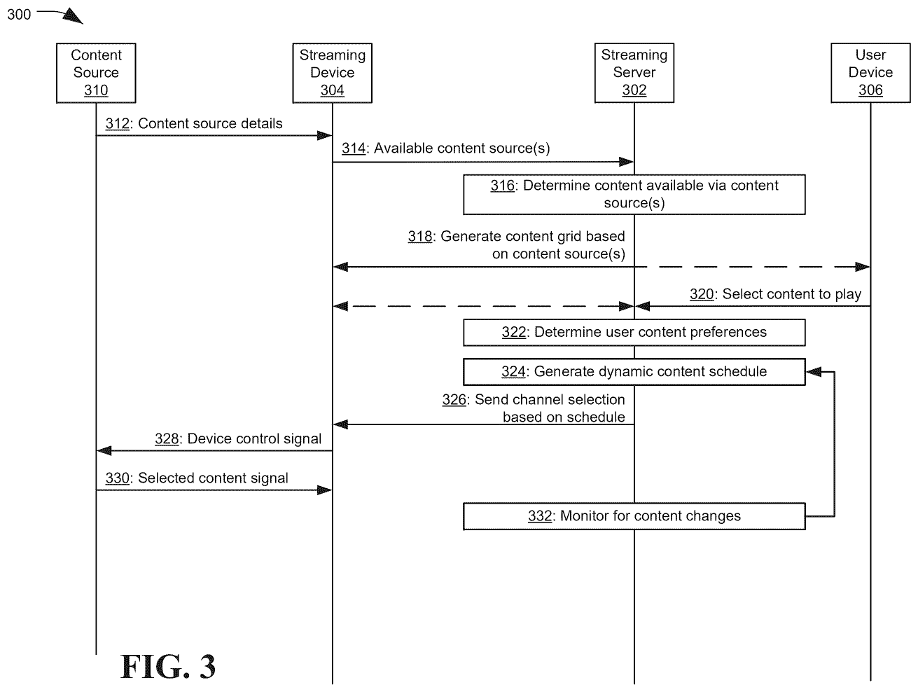

In some embodiments, the streaming service may be configured to monitor and dynamically update the programming for content schedule 216. For example, the streaming service may monitor live sports score to determine whether a sporting event has ended and the channel can be changed according to the schedule 216, or whether the channel should be left on the sporting event until it has concluded. In another example, the streaming service may regularly check the schedule 216 against publicly available EPGs, to determine whether any of the scheduled content will be impacted by programming changes. An example process flow for a system configured to perform dynamic content scheduling is described in regard to FIG. 3.

FIG. 3 depicts a flowchart 300 of an example method for implementing a dynamic content scheduler, in accordance with certain embodiments of the present disclosure. In particular, the method of FIG. 3 may be a process for determining available content from content sources connected to a streaming device, generating a content schedule based on the available content, and controlling the streaming device to change between channels and content sources automatically according to the schedule. The method may be implemented by components such as content source 310, streaming device 304, streaming server 302, and user device 306. The components of flowchart 300 may correspond to elements shown in FIG. 1, such as streaming service 102, streaming device 104, content source 310, and user device 106. Other components, such as EPG 112, or some combination thereof, may also be included in the method of FIG. 3.

The method may include providing content source details from content source 310 to streaming device 304, at 312. Content source details may include information such as a type of content source device 310, display and operational characteristics of content provided from the content source 310, and an indication of the capabilities of the content source 310. In an example embodiment, the content source details may be provided via EDID information provided or exchanged when content source 310 is connected to streaming device 304 via an HDMI cable. In some examples, content source details may also include program content available via the content source, or an indication of how or where to access available content or an EPG for the content source 310.

At 314, the method may include the streaming device 304 providing the streaming service 302 with information on the available content sources, as received via the content source details 312. Based on the content source details, the streaming server 302 may determine content available via the content sources, at 316. The determined content may include content available from the streaming server 302 or streaming service itself. Determining available content may include accessing EPGs, content databases, live update information, or other publicly available data for the content sources.

At 318, the method may include the streaming server 302 generating a content grid, database, navigation menu, or other UI element for the content available via content sources 310. The content grid may be provided to streaming device 304, for display via a dashboard or home screen of the streaming device, with various content sources 310 depicted as tiles from which a user can select content to view. The content grid may also be provided as a scheduling interface, which may be presented via streaming device 304 or user device 306 to enable a user to create a dynamic content schedule for controlling the display of streaming device 304.

At 320, a user may select content to play, which information may be provided to streaming server 302. For example, a user may utilize streaming device 304 or user device 306 to enter viewing preferences, a show to currently play at streaming device 304, or content to add to a schedule. In one example, a user may select a program to display now via user device 306, which selection is received at streaming server 302, which in turn may issue a command to streaming device 304 to change to the requested content.

At 322, the streaming server 302 may determine user content preferences for what to display at streaming device 304. The streaming server 302 may determine user content preferences from one or more of a variety of information sources. For example, a user may directly specify what content to watch or channel to view, e.g., via user device 305 or streaming device 304. The streaming server 302 may maintain a log or keep records of viewing habits or history to determine what content a user prefers, and potentially at what times. Streaming server 302 may also evaluate demographic information, such as a location of the streaming device 304 (e.g. a state or city), a type of venue in which the streaming device is situated (e.g., a home, a bar, a restaurant, a clothing store, etc.), a type of clientele of the venue (e.g., country-western, sports-affiliated, target age, etc.), or other details to evaluate appropriate content. A user may also supply general or specific guidance on what types of content to play and when. Based on the various information sources, the streaming server 302 may use a machine learning algorithm or operator inputs to determine preferred content for a particular streaming device 304.

At 324, the streaming server 302 may generate a dynamic content schedule. The content schedule may be user-generated, such as by having a user add specific content from specific content sources 310 to a schedule. In another example, the content schedule may be automatically (e.g., via machine learning or programmed algorithm) or manually (e.g., via a streaming server operator) generated based on the user content preferences determined at 322.

The streaming server 302 may send channel selection commands to the streaming device 304 based on the generated schedule, at 326. For example, the streaming server 302 may send instructions on what content source (e.g., input port) and channel to switch to at a specified time based on the content included in the schedule. In another example, the streaming server 302 may send a copy of the content schedule to the streaming device 304, which in turn may follow the schedule and change inputs and channels internally as defined in the schedule.

In response to the content selection information from the schedule, the streaming device 304 may send a device control signal to the appropriate content source, at 310. For example, the streaming device 304 may employ CEC signals over an HDMI connection to control a content source device 310 to change to a particular channel or content feed. In response, the content source 310 may provide the selected content signal to the streaming device 304, which may display the content on a screen or television. The streaming service 302 may continue to send channel selection signals based on the schedule (or the streaming device 304 may continue to follow a local copy of the schedule) at 326, and change the content source and channel as appropriate.

At 332, the streaming server 302 may monitor for content changes. Monitoring for content changes may include reviewing EPGs for the content source 310, or other data sources such as live sports feeds, to determine whether content on the schedule is expected to end earlier or later than expected, or will no longer be available. In another example, content changes may come from a user, e.g., via user device 306, adjusting or changing what content is included on the schedule. If content changes are determined, the method may include updating the dynamic content schedule at 324. Updating the content schedule may adjust when channel selection signals are sent to streaming device 304. Alternately, a copy of the updated content schedule may be provided to the streaming device 304, so that the streaming device follows the most up-to-date version of the schedule.

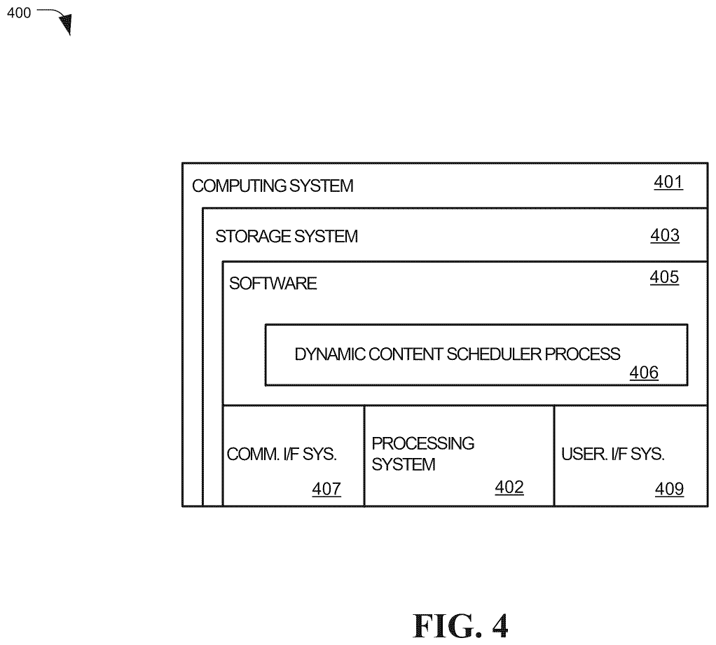

It may be noted that a user may override a scheduled content block at any time by manually changing a channel or content source at the streaming device 304. Based on default or configured settings, the streaming server 302 or streaming device 304 may continue to monitor the schedule and change the content at the next scheduled content change, or the streaming device may turn off the automated schedule feature in response to a user taking over control. Other embodiments are also possible. An example system configured to implement a dynamic content scheduler is described in regard to FIG. 4.

FIG. 4 is a diagram of an example system 400 configured to implement a dynamic content scheduler, in accordance with certain embodiments of the present disclosure. System 400 may be an example of an apparatus including a computing system 401 that is representative of any system or collection of systems in which the various processes, systems, programs, services, and scenarios disclosed herein may be implemented. For example, computing system 401 may be an example of streaming service or server 102, streaming device 104, user device 106, content sources 110, EPGs 112, network 108, or any of the subcomponents depicted in system 100 of FIG. 1. Examples of computing system 401 include, but are not limited to, server computers, desktop computers, laptop computers, smart devices, routers, switches, web servers, cloud computing platforms, and data center equipment, as well as any other type of physical or virtual server machine, physical or virtual router, cloud containerized application, and any variation or combination thereof.

Computing system 401 may be implemented as a single apparatus, system, or device or may be implemented in a distributed manner as multiple apparatuses, systems, or devices. Computing system 401 may include, but is not limited to, processing system 402, storage system 403, software 405, communication interface system 407, and user interface system 409. Processing system 402 may be operatively coupled with storage system 403, communication interface system 407, and user interface system 409.

Processing system 402 may load and execute software 405 from storage system 403. Software 405 may include and implement dynamic content scheduler process 406, which may be representative of any of the operations for determining available content sources for a streaming device, determining content available from the content sources, determining customer preferences or appropriate content for a selected streaming device, generating a content schedule to automatically change content displayed on the streaming device, and monitoring for updates to the content schedule, as discussed with respect to the preceding figures. When executed by processing system 402, software 405 may direct processing system 402 to operate as described herein for at least the various processes, operational scenarios, and sequences discussed in the foregoing implementations. Computing system 401 may optionally include additional devices, features, or functionality not discussed for purposes of brevity.

In some embodiments, processing system 402 may comprise a micro-processor and other circuitry that retrieves and executes software 405 from storage system 403. Processing system 402 may be implemented within a single processing device but may also be distributed across multiple processing devices or sub-systems that cooperate in executing program instructions. Examples of processing system 402 may include general purpose central processing units, graphical processing units, application specific processors, and logic devices, as well as any other type of processing device, combinations, or variations thereof.

Storage system 403 may comprise any memory device or computer readable storage media readable by processing system 402 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 403 may also include computer readable communication media over which at least some of software 405 may be communicated internally or externally. Storage system 403 may be implemented as a single storage device but may also be implemented across multiple storage devices or sub-systems co-located or distributed relative to each other. Storage system 403 may comprise additional elements, such as a controller, capable of communicating with processing system 402 or possibly other systems.

Software 405 (including dynamic content scheduler process 406 among other functions) may be implemented in program instructions that may, when executed by processing system 402, direct processing system 402 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 405 may include additional processes, programs, or components, such as operating system software, virtualization software, or other application software. Software 405 may also comprise firmware or some other form of machine-readable processing instructions executable by processing system 402.

In general, software 405 may, when loaded into processing system 402 and executed, transform a suitable apparatus, system, or device (of which computing system 401 is representative) overall from a general-purpose computing system into a special-purpose computing system as described herein. Indeed, encoding software 405 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-storage media are characterized as primary or secondary storage, as well as other factors.

For example, if the computer readable storage media are implemented as semiconductor-based memory, software 405 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 407 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 401 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
implementing a dynamic content scheduler for a streaming device, including:
determining a content source device connected to the streaming device;
determining all content available to the streaming device based on the content source device;
generating a content schedule of video to play at the streaming device based on the all content; and
controlling the streaming device to play the video based on the content schedule, including directing the streaming device to send control signals to the content source device.

2. The method of claim 1 further comprising:
implementing the dynamic content scheduler at a streaming server remote from the streaming device, including:
determining the content source device based on receiving information on the content source device from the streaming device.

3. The method of claim 2 further comprising:
providing streaming content from the streaming server to the streaming device; and
determining the all content available to the streaming device, including first content from the content source device and the streaming content from the streaming server.

4. The method of claim 3 wherein:
the content source device is one of a plurality of content source devices connected to the streaming device; and
the method further comprises determining the all content available to the streaming device based on content available from each of the plurality of content source devices.

5. The method of claim 4 further comprising:
adding the content available from each of the plurality of content source devices to a user interface (UI) of the streaming device.

6. The method of claim 5 further comprising:
receiving a user selection of programming to add to the content schedule; and
generating the content schedule based on the user selection.

7. The method of claim 5 further comprising:
determining attribute information associated with the streaming device; and
automatically generating the content schedule based on the attribute information.

8. The method of claim 7 further comprising:
determining the all content available to the streaming device, including accessing an electronic program guide associated with the content source device.

9. The method of claim 8 further comprising:
monitoring for content changes affecting the content schedule; and
dynamically updating the content schedule based on the content changes.

10. A system comprising:
a streaming service configured to implement a dynamic content scheduler for a streaming device, the streaming service physically remote from the streaming device, including:
receive information from the streaming device identifying a content source device connected to the streaming device;
determine all content available to the streaming device based on the content source device;
generate a content schedule of video to play at the streaming device based on the all content; and
control the streaming device to play the video based on the content schedule, including directing the streaming device to send control signals to the content source device.

11. The system of claim 10, wherein:
the content source device is one of a plurality of content source devices connected to the streaming device;
the streaming service further configured to:
provide streaming content from the streaming service to the streaming device; and
determine the all content available to the streaming device based on content available from each of the plurality of content source devices and the streaming content from the streaming service.

12. The system of claim 11 comprising the streaming service further configured to:
determine the all content available to the streaming device, including accessing an electronic program guide associated with the content source device; and
add the content available from each of the plurality of content source devices to a user interface (UI) of the streaming device.

13. The system of claim 10 comprising the streaming service further configured to:
receive a user selection of programming to add to the content schedule; and
generate the content schedule based on the user selection.

14. The system of claim 10 comprising the streaming service further configured to:
determine attribute information associated with the streaming device; and
automatically generate the content schedule based on the attribute information.

15. The system of claim 10 comprising the streaming service further configured to:
monitor for content changes affecting the content schedule; and
dynamically update the content schedule based on the content changes.

16. A memory device storing instructions that, when executed, cause a processor to perform a method comprising:
implementing, via a streaming service physically remote from a streaming device, a dynamic content scheduler for the streaming device, including:
determining a content source device connected to the streaming device;
determining all content available to the streaming device based on the content source device;
generating a content schedule of video to play at the streaming device based on the all content; and
controlling the streaming device to play the video based on the content schedule, including directing the streaming device to send control signals to the content source device.

17. The memory device of claim 16, wherein:
the content source device is one of a plurality of content source devices connected to the streaming device;
the instructions, when executed, cause the processor to perform the method further comprising:
provide streaming content from the streaming service to the streaming device;
determine the all content available to the streaming device based on content available from each of the plurality of content source devices and the streaming content from the streaming service;
controlling the streaming device to play the video further includes sending a signal, based on a programming change in the content schedule, directing the streaming device to:
switch to an input of a selected one of the plurality of content source devices; and
send a control signal causing the selected one of the plurality of content source devices to switch to specified content channel.

18. The memory device of claim 16 storing instructions that, when executed, cause the processor to perform the method further comprising:
receiving a user selection of programming to add to the content schedule; and
generating the content schedule based on the user selection.

19. The memory device of claim 16 storing instructions that, when executed, cause the processor to perform the method further comprising:
determining attribute information associated with the streaming device; and
automatically generating the content schedule based on the attribute information.

20. The memory device of claim 16 storing instructions that, when executed, cause the processor to perform the method further comprising:
monitoring for content changes affecting the content schedule; and
dynamically updating the content schedule based on the content changes.
